(19) United States
(12) Patent Application Publication
(10) Pub. No.: US 2014/0080541 A1
(43) Pub. Date: Mar. 20, 2014

(54) MOBILE COMMUNICATION TERMINAL

(71) Applicant: DESIGNLIMIT CO.,LTD, Seoul (KR)

(72) Inventor: Joon SON, Seoul (KR)

(21) Appl. No.: 13/873,366

(22) Filed: Apr. 30, 2013

(30) Foreign Application Priority Data
Sep. 14, 2012 (KR) 10-2012-0102158

(51) Int. Cl. H04M 1/02

(52) U.S. Cl. CPC H04M 1/026
USPC 455/556.1; 455/550.1; 455/566

(57) ABSTRACT

A mobile communication terminal has a basic button unit including at least one of a home button, a back button, an option button, and a search button, and at least one button of the basic button unit is formed on a side of the mobile communication terminal. The mobile communication terminal may further include a button signal recognizer configured to generate an additional function event signal according to a previously set form of a button signal generated from the button formed on the side of the mobile communication terminal and an additional function performer configured to perform an additional function previously set in an application currently executed in the mobile communication terminal or a current screen state when the additional function event signal is generated.

### CROSS-REFERENCE TO RELATED APPLICATION

This application claims priority to and the benefit of Korean Patent Application No. 10-2012-0102158, filed on Sep. 14, 2012, the disclosure of which is incorporated herein by reference in its entirety.

### BACKGROUND

1. Field of the Invention

The present invention relates to a mobile communication terminal, and more particularly, to a mobile communication terminal easily manipulated with one hand.

2. Discussion of Related Art

With the recent development in information technology (IT), wireless communication technology, wireless Internet technology, etc., a mobile communication terminal provides various functions such as a camera function, a Moving Picture Experts Group (MPEG) audio layer 3 (MP3) function, a digital multimedia broadcasting (DMB) function, a game function, a video telephony function, a data communication function, and a moving picture function, as well as basic functions such as voice telephony and message exchange, and accordingly, most people have mobile communication terminals.

FIG. 1 is a diagram of a general mobile communication terminal, and FIG. 2 shows pictures of general mobile communication terminals.

Referring to FIG. 1 and FIG. 2, in a mobile communication terminal 10, a display 11 is formed on a front, a volume button 12 is formed on one side, and a power button 13 is formed on the other side. Also, a basic button unit 14 is formed at a lower end of the front of the mobile communication terminal 10. The basic button unit 14 includes at least one of, for example, a home button, a back button, an option button, and a search button. As an example, at the lower end of the front of the mobile communication terminal 10, an option button 14-1, a home button 14-2, and a back button 14-3 may be sequentially formed from left to right.

In general, the basic button unit 14 is formed at the lower end of the front of the mobile communication terminal 10 and implemented using touch-type buttons, and thus it is difficult for a user to manipulate the mobile communication terminal 10 with one hand. Specifically, when the user is holding the mobile communication terminal 10 in his or her left hand, the user usually touches the basic button unit 14 with his or her left thumb. At this time, the user can accurately touch the option button 14-1 located near the left thumb, but it is difficult to touch the back button 14-3 far away from the left thumb. Even if the back button 14-3 is touched, another button (e.g., the home button 14-2) may be touched at the same time, which makes it difficult to perform an operation wanted by the user. In this case, the other hand should be used to accurately touch and manipulate the back button 14-3.

As described above, the conventional mobile communication terminal 10 has the basic button unit 14 at the lower end of the front thereof, and it is difficult to manipulate the mobile communication terminal 10 with one hand. Thus, as shown in pictures of FIG. 3, a person with only one hand, a person with two hands one of which is disabled, a person holding an object in one hand, a person holding a baby in his or her one arm, a person holding a strap with one hand, etc. have much difficulty in using the mobile communication terminal 10. In addition, since the size of a smart phone tends to increase compared to that of the past, it becomes more difficult for a user to manipulate the mobile communication terminal 10 with one hand when the basic button unit 14 is located at the lower end of the front of the mobile communication terminal 10.

Furthermore, the basic button unit 14 is implemented using the touch-type buttons, and thus a touch module constituting the basic button unit 14 should be additionally present at the lower end of the mobile communication terminal 10. FIG. 4 is a diagram of a touch module of a basic button unit in a conventional mobile communication terminal.

Referring to FIG. 4, a touch module 50 constituting the basic button unit 14 includes a substrate 51 and a touch-sensing layer 53.

Here, the substrate 51 may be formed of a flexible printed circuit board (FPCB). The substrate 51 is electrically connected to a main board (not shown) of the mobile communication terminal 10. On the substrate 51, a light-emitting device (not shown) may be formed. When the power of the mobile communication 10 is turned on, the substrate 51 may activate the respective buttons 14-1, 14-2, and 14-3 through the light-emitting device (not shown).

The touch-sensing layer 53 senses whether or not a user touches the basic button unit 14. The touch-sensing layer 53 may be formed of, for example, touch sensors. In this case, the touch sensors are formed at positions corresponding to the respective buttons 14-1, 14-2, and 14-3. Sensors of various types such as a resistive overlay type, a capacitive type, a surface acoustic wave (SAW) type, and a strain gauge type can be used as the touch sensors.

Since the conventional mobile communication terminal 10 should additionally have the touch module 50 constituting the basic button unit 14 as described above, a cost for designing and manufacturing the touch module 50 is additionally required. Also, the additional touch module 50 complicates the overall structure and design of the mobile communication terminal 10 and increases the manufacturing cost.

Meanwhile, even when the basic button unit 14 is formed of press-type buttons rather than touch-type buttons, the basic button unit 14 occupies the lower end of the front of the mobile communication terminal 10, and the screen size of the display 11 is limited.

### SUMMARY

The inventive concept is directed to providing a mobile communication terminal that is easily manipulated with one hand.

The inventive concept is also directed to providing a mobile communication terminal whose structure and design can be simplified.

The inventive concept is also directed to providing a mobile communication terminal in which a display having a large screen can be implemented.

According to an aspect of the inventive concept, there is provided a mobile communication terminal having a basic button unit including at least one of a home button, a back button, an option button, and a search button, wherein at least one button of the basic button unit is formed on a side of the mobile communication terminal.

The button of the basic button unit formed on the side of the mobile communication terminal may be formed of a press-type button.

All the buttons of the basic button unit may be formed on the side of the mobile communication terminal, and a display screen of the mobile communication terminal may be extended to a lower end of a front of the mobile communication terminal.

The basic button unit may be formed of one button formed on a side of the mobile communication terminal, and the one button may perform a function of at least one of the home button, the back button, the option button, and the search button.

The mobile communication terminal further includes: a button signal recognizer configured to generate an additional function event signal according to a previously set form of a button signal generated from the button formed on the side of the mobile communication terminal; and an additional function performer configured to perform an additional function previously set in an application currently executed in the mobile communication terminal or a current screen state when the additional function event signal is generated.

Some buttons of the basic button unit may be formed at an upper end of a left side of the mobile communication terminal, and the other buttons may be formed at an upper end of a right side of the mobile communication terminal.

Button functions of the respective buttons of the basic button unit may be exchanged according to a setting of a user.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram of a general mobile communication terminal;

FIG. 2 shows pictures of the fronts of general mobile communication terminals;

FIG. 3 shows situations in which it is difficult to manipulate a conventional mobile communication terminal with one hand;

FIG. 4 is a diagram of a touch module of a basic button unit in a conventional mobile communication terminal;

FIG. 5 is a diagram of a mobile communication terminal according to an exemplary embodiment of the present invention;

FIG. 6 is a diagram for comparing a state in which a conventional mobile communication terminal is used with a state in which a mobile communication terminal according to an exemplary embodiment of the present invention is used;

FIG. 7 shows an expanded display screen and battery size of a mobile communication terminal according to an exemplary embodiment of the present invention;

FIG. 8 is a diagram illustrating a button function changing process according to an exemplary embodiment of the present invention;

FIG. 9 shows a state in which buttons formed on both sides of a mobile communication terminal according to an exemplary embodiment of the present invention are pressed at the same time; and

FIG. 10 is a block diagram of a mobile communication terminal according to an exemplary embodiment of the present invention.

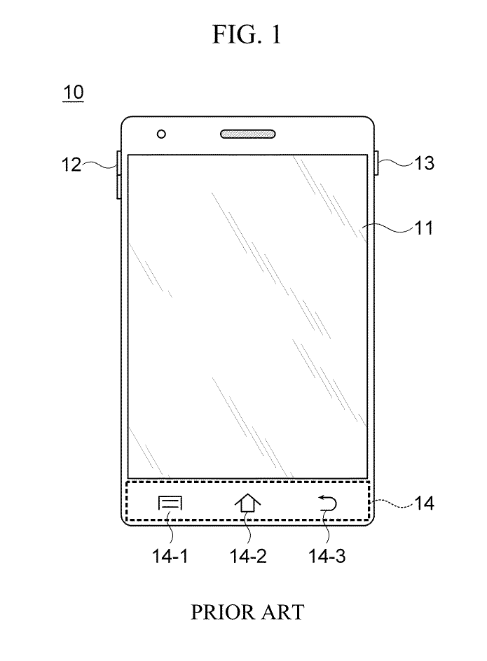

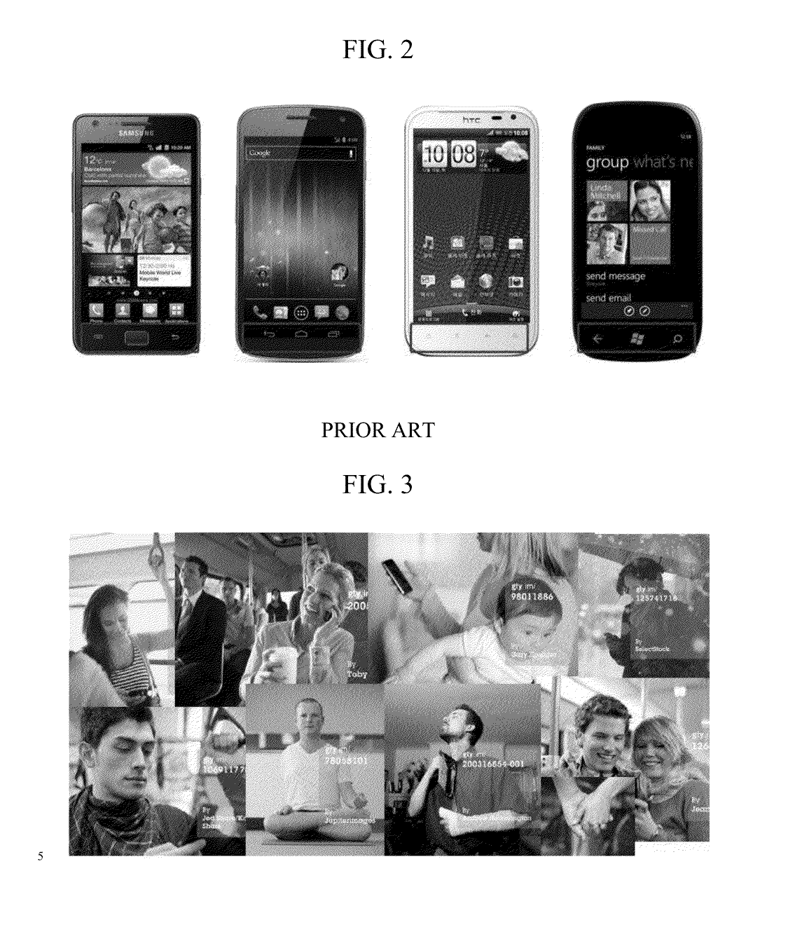

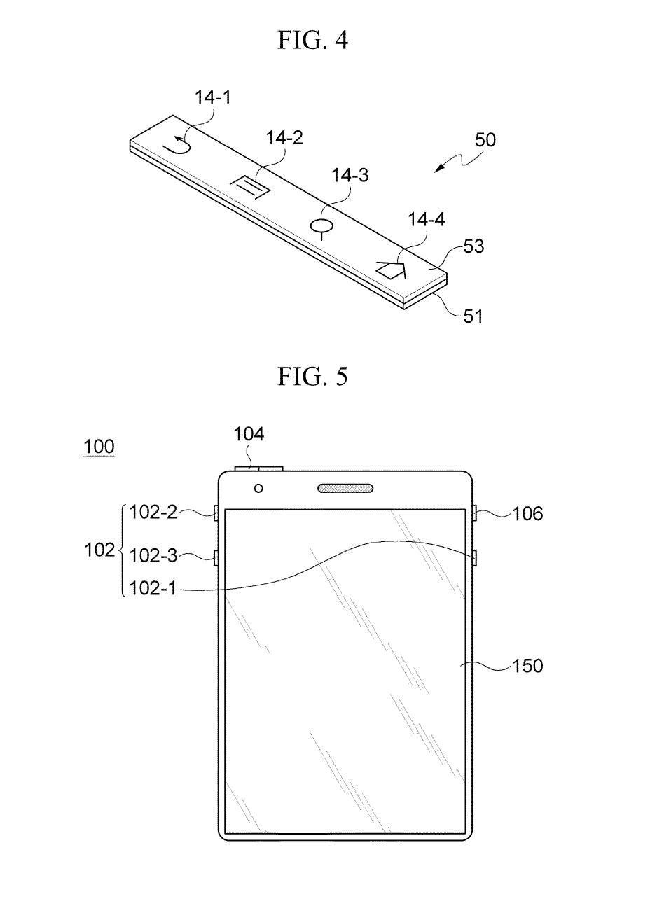

### DETAILED DESCRIPTION OF EXEMPLARY EMBODIMENTS

Hereinafter, a mobile communication terminal according to detailed embodiments of the present invention will be described with reference to FIG. 5 to FIG. 10. However, the embodiments are merely examples and are not to be construed as limiting the present invention.

When it is determined that the detailed description of known art related to the present invention may obscure the gist of the present invention, the detailed description thereof will be omitted. Terminology described below is defined considering functions in the present invention and may vary according to a user's or operator's intention or usual practice. Thus, the meanings of the terminology should be interpreted based on the overall context of the present specification.

The spirit of the present invention is determined by the claims, and the following exemplary embodiments are provided to efficiently describe the spirit of the present invention to those of ordinary skill in the art.

FIG. 5 is a diagram of a mobile communication terminal according to an exemplary embodiment of the present invention. In FIG. 5, the mobile communication terminal is a smartphone.

Referring to FIG. 5, a mobile communication terminal 100 includes a basic button unit 102, a volume button 104, and a power button 106. Here, a part or the whole of the basic button unit 102 is formed on a side of the mobile communication terminal 100.

The basic button unit 102 denotes a button that is frequently used to manipulate and cause the mobile communication terminal 100 to operate. The basic button unit 102 includes at least one of, for example, a home button, a back button, an option button (or setting button), and a search button. As an example, the basic button unit 102 is shown to include a home button 102-1, a back button 102-2, and an option button 102-3, and to be formed on a side of the mobile communication terminal 100, but is not limited to the buttons or the position.

The home button 102-1 may be formed on a right side of the mobile communication terminal 100 together with the power button 106. The power button 106 serves to turn on or off the mobile communication terminal 100. The home button 102-1 may function to, for example, display a home screen on a display 150 of the mobile communication terminal 100 or activate the mobile communication terminal 100.

Here, the home button 102-1 is shown to be formed under the power button 106, but is not limited to the position, and the positions of the home button 102-1 and the power button 106 may be exchanged. Also, the home button 102-1 is shown to be formed at an upper end on the right side, but is not limited to the position, and may be formed at a position other than the upper end on the right side of the mobile communication terminal 100.

The back button 102-2 may be formed at an upper end on a left side of the mobile communication terminal 100. The back button 102-2 may function to, for example, display a previous screen on the display 150 of the mobile communication terminal 100 or terminate an application or operation performed by the mobile communication terminal 100. The option button 102-3 may be formed under the back button 102-2 on the left side of the mobile communication terminal 100. The option button 102-3 may function to, for example, display an option menu screen on the display 150 of the mobile communication terminal 100.

Here, the back button 102-2 and the option button 102-3 are shown to be sequentially formed at the upper end on the left side, but are not limited to the positions, and the positions of the back button 102-2 and the option button 102-3 may be exchanged. Also, although the back button 102-2 and the option button 102-3 are shown to be formed at the upper end on the left side, the positions are not limited to the upper end, and the back button 102-2 and the option button 102-3 may be formed at positions on the left side other than those at the upper end.

The volume button 104 may be formed on an upper side of the mobile communication terminal 100. In other words, although a volume button is generally formed on the left side or the right side of a mobile communication terminal, in an exemplary embodiment of the present invention, the basic button unit 102 is formed on the left side and the right side of the mobile communication terminal 100, and thus the volume button 104 can be moved and formed on the upper side of the mobile communication terminal 100.

Although the home button 102-1 is shown to be formed on the right side of the mobile communication terminal 100 and the back button 102-2 and the option button 102-3 are shown to be formed on the left side of the mobile communication terminal 100, the positions are not limited to these, and the entire basic button unit 102 may be formed on the left side or the right side of the mobile communication terminal 100. In addition, a part of the basic button unit 102 may be formed on the left side of the mobile communication terminal 100, and the other part may be formed on the right side of the mobile communication terminal 100. Further, the positions at which the basic button unit 102 is formed are not limited to the left side and the right side of the mobile communication terminal 100, and a part or the whole of the basic button unit 102 may be formed on at least one of the upper side and a lower side of the mobile communication terminal 100.

Here, the basic button unit 102 is shown to include the plurality of buttons, that is, the home button 102-1, the back button 102-2, and the option button 102-3, but is not limited to these buttons, and may be formed of one button. In this case, respective functions of the basic button unit 102 may be integrated and applied to the one button. For example, the one button may be set to perform the function of the back button when it is pressed for a short time, the function of the home button when it is pressed for a long time, and the function of the option button when it is pressed twice in succession for short times. In this case, using the one button, it is possible to perform all the functions of the basic button unit 102.

The basic button unit 102 may be formed of press-type buttons, but is not limited to them. Here, a press-type button denotes a button that generates a button signal when a user applies pressure to the button (i.e., when the user presses the button) and a switch comes in contact with another switch. When the basic button unit 102 is implemented using press-type buttons, it is possible to simply make up the basic button unit 102 compared to a case of implementing the basic button unit 102 using touch-type buttons. In other words, when the basic button unit 102 is formed of press-type buttons, the number of parts constituting the basic button unit 102 is reduced and its design is simplified. Thus, compared to the case of implementing the basic button unit 102 using touch-type buttons, it is possible to simply make up the basic button unit 102 while reducing the manufacturing cost. Here, the basic button unit 102 is electrically connected to a main board (not shown) of the mobile communication terminal 102.

Meanwhile, although the entire basic button unit 102 is shown to be formed on the sides of the mobile communication terminal 100, the positions are not limited to the sides. A part of the basic button unit 102 may be formed at a lower end of the front of the mobile communication terminal 100, and the other part of the basic button unit 102 may be formed on a side of the mobile communication terminal 100. For example, the home button 102-1 may be formed at the lower end of the front of the mobile communication terminal 100, and the back button 102-2 and the option button 102-3 may be formed on a side of the mobile communication terminal 100. Here, the home button 102-1 may be formed at the center of the lower end of the front of the mobile communication terminal 100 such that the home button 102-1 can be manipulated by both a left hand and a right hand.

In an exemplary embodiment of the present invention, a part or the whole of the basic button unit 102 is formed on a side of the mobile communication terminal 100, such that the mobile communication terminal 100 can be easily manipulated with only one hand. In other words, while the mobile communication terminal 100 is held in one hand, it is possible to manipulate the mobile communication terminal 100 by pressing various buttons (e.g., the basic button unit, the volume button, and the power button) formed on sides of the mobile communication terminal 100 with the hand.

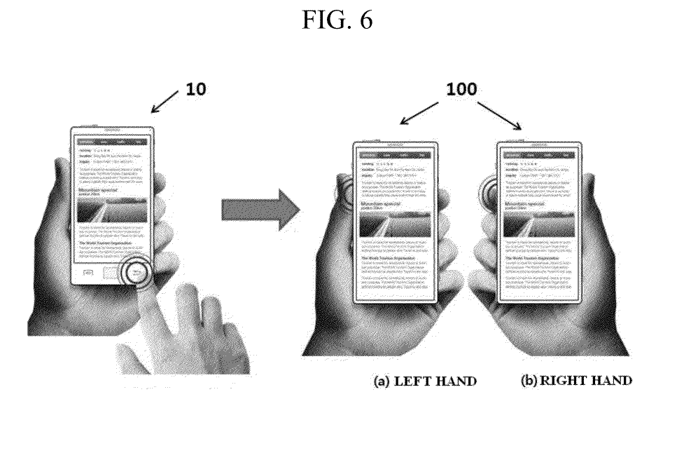

FIG. 6 is a diagram for comparing a state in which a conventional mobile communication terminal 10 is used with a state in which a mobile communication terminal 100 according to an exemplary embodiment of the present invention is used.

Referring to FIG. 6, in a conventional mobile communication terminal 10, a basic button unit is implemented at a lower end of the front of the mobile communication terminal 10 using touch-type buttons, and thus it is difficult to accurately manipulate the mobile communication terminal 10 with only one hand. Thus, to accurately manipulate the mobile communication terminal 10, the basic button unit should be touched by a right hand while the mobile communication terminal 10 is held in a left hand.

On the other hand, in the mobile communication terminal 100 according to an exemplary embodiment of the present invention, a basic button unit is formed on a side of the mobile communication terminal 100, and thus it is possible to accurately manipulate the mobile communication terminal 100 by pressing the basic button unit with a finger of one hand (left hand or right hand) while the mobile communication terminal 100 is held in the one hand.

In an exemplary embodiment of the present invention, even a person with only one hand, a person with two hands one of which is disabled, a person holding an object in one hand, etc. can easily manipulate the mobile communication terminal 100 with only one hand, and convenience of the users can be improved. In this way, users in various physical conditions or situations are taken into consideration, and thus it is possible to ensure a user-friendly and emotional marketing point. Also, by providing a mobile communication terminal of a new structure differentiated from a mobile communication terminal of a conventional structure, it is possible to achieve a creative and innovative company image that leads the corresponding field.

Meanwhile, in the mobile communication terminal 100 according to an exemplary embodiment of the present invention, the basic button unit 102 is formed on a side of the mobile communication terminal 100 and implemented using press-type buttons, and thus an additional touch module required for a conventional basic button unit is not required at the lower end of the front of the mobile communication terminal 100. In this case, a design and structure of the mobile communication terminal 100 can be simplified compared to the conventional mobile communication terminal 10. Also, the size and weight of the mobile communication terminal 100 can be reduced by the size and weight of a touch module compared to the conventional mobile communication terminal 10. Moreover, simplification of a button structure improves the convenience and efficiency of post-sales customer service, and so on.

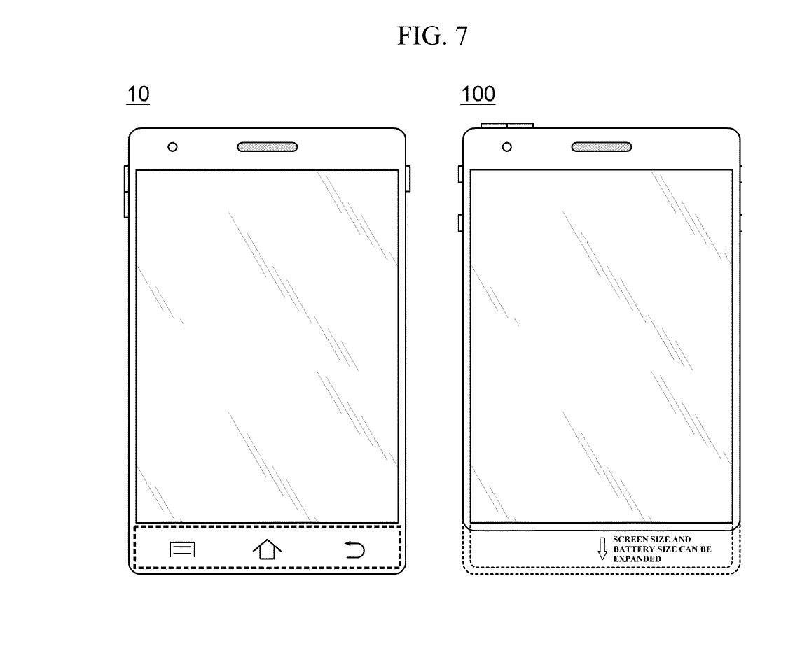

In addition, by forming the basic button unit 102 on the side of the mobile communication terminal 100, it is possible to implement the front of the mobile communication terminal 100 as a full liquid crystal display (LCD) screen. In other words, as shown in FIG. 7, when the mobile communication terminal 100 is formed in the same size as the conventional mobile communication terminal 10, a portion in which an conventional basic button unit has been present (i.e., a portion in which a touch module has been present) can be included in a display screen, and it is possible to provide a bigger screen. In other words, since the display screen can be extended to the lower end of the front of the mobile communication terminal, it is possible to provide a bigger screen than the conventional mobile communication terminal having the same size. Also, since a battery size can be expanded to the portion in which a conventional basic button unit has been present, it is possible to increase a battery capacity.

Furthermore, by forming the basic button unit on the side of the mobile communication terminal, it is possible to extend the width of the mobile communication terminal as well as the length as long as a user can hold the mobile communication terminal with one hand. Thus, it is possible to satisfy the user's demand for a large screen and also to provide convenience for one-hand manipulation. In other words, by forming the basic button unit on the side of the mobile communication terminal, the user can easily manipulate the mobile communication terminal with one hand even when the size of the mobile communication terminal increases. Accordingly, it is possible to keep up with a trend in the increasing size of a mobile communication terminal and also to improve convenience of the user.

Meanwhile, functions of the buttons formed on respective sides of the mobile communication terminal 100 may be changed according to a setting of a user. For example, functions of the power button 106 and the home button 102-1 in the mobile communication terminal 100 may be exchanged according to a setting of a user. Here, the mobile communication terminal 100 has a “menu for changing button functions” in which functions of buttons can be changed, and a user can exchange functions of the power button 106 and the home button 102-1 through the menu for changing button functions.

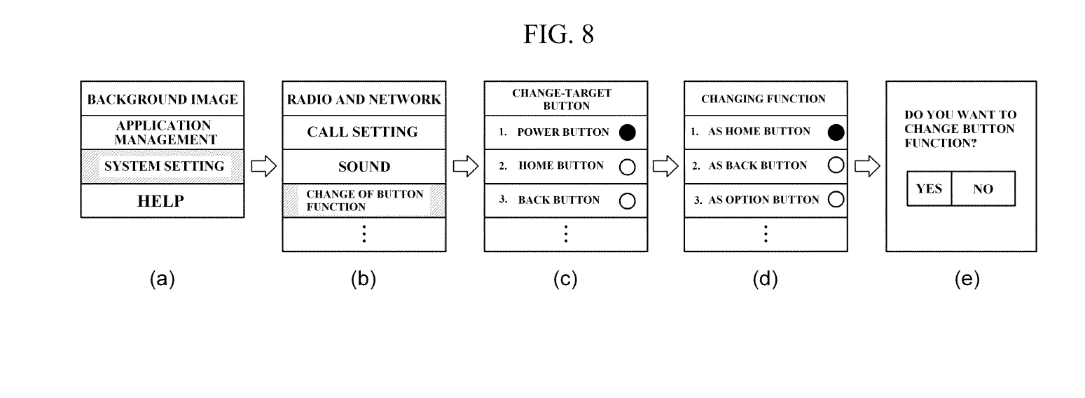

It has been mentioned above that the functions of the power button 106 and the home button 102-1 are exchanged, but the functions of the home button 102-1, the back button 102-2, the option button 102-3, the volume button 104, and the power button 106 as well as the functions of the power button 106 and the home button 102-1 can be exchanged in various ways. In this case, the user can reset functions of respective buttons for the convenience of use, and use the functions. This will be described in detail with reference to FIG. 8.

FIG. 8 is a diagram illustrating a button function changing process according to an exemplary embodiment of the present invention. Referring to FIG. 8, when a user presses the option button 102-3, the mobile communication terminal 100 displays option menus on the display 150 ((a) of FIG. 8). The option menus may include, for example, “Background Image,” “Application Management,” “System Setting,” and “Help.”

Next, when the user selects “System Setting” from among the option menus, the mobile communication terminal 100 displays detailed menu items for system setting on the display 150 ((b) of FIG. 8). Here, “Change of Button Function” is provided as a detailed menu item for system setting.

Next, when the user selects “Change of Button Function” from among the detailed menu items for system setting, the mobile communication terminal 100 displays menus for selecting a change-target button (i.e., menus through which the user can select a button whose function will be changed) on the display 150 ((c) of FIG. 8). Here, as the change-target button menus, buttons formed on sides of the mobile communication terminal 100, for example, the home button 102-1, the back button 102-2, the option button 102-3, the volume button 104, and the power button 106, may be displayed.

Next, when the user selects “Power Button” from among the change-target button menus, the mobile communication terminal 100 displays changing function menus (i.e., menus through which the user can select a function of the selected button) on the display 150 ((d) of FIG. 8). Here, as the changing function menus, functions of buttons other than the button selected by the user (i.e., the power button) can be displayed.

Next, when the user selects “As Home Button” from among the changing function menus to change the function of the power button to that of the home button, the mobile communication terminal 100 may display a screen asking whether to change the function of the corresponding button on the display 150 ((e) of FIG. 8). Here, when the user selects “Yes,” the mobile communication terminal 100 changes the function of the current power button to the function of the home button.

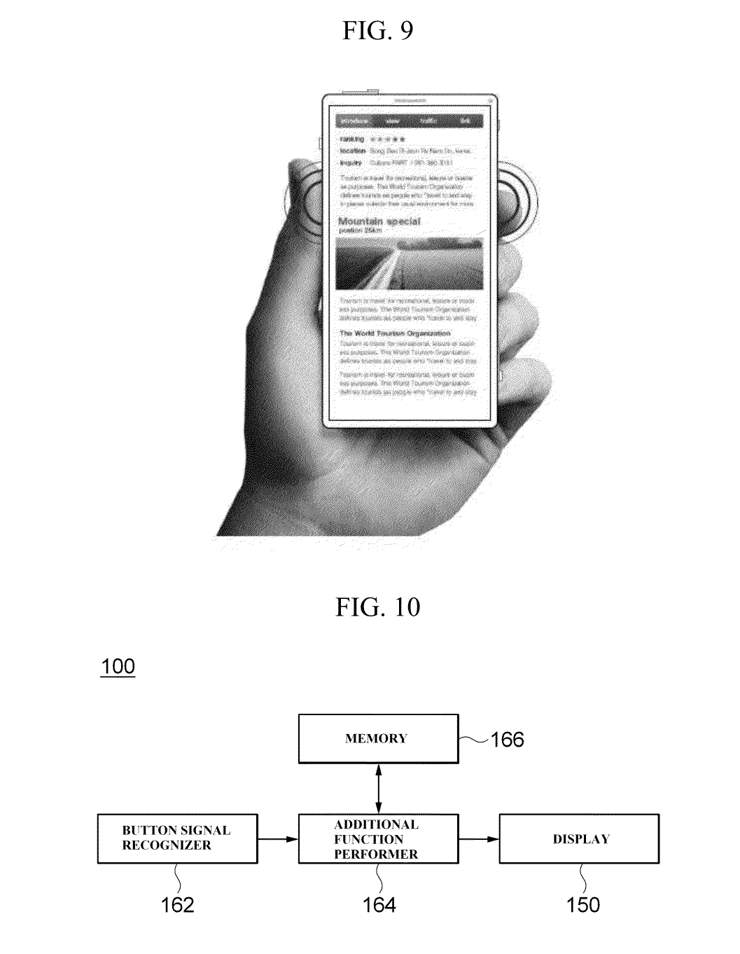

In addition, when two buttons among buttons formed on sides of the mobile communication terminal 100 are pressed at the same time as shown in FIG. 9, the mobile communication terminal 100 may perform an additional function previously set in an application currently executed in the mobile communication terminal 100 or a current screen state. This will be described in detail below with reference to FIG. 10.

FIG. 10 is a block diagram of a mobile communication terminal 100 according to an exemplary embodiment of the present invention. Referring to FIG. 10, the mobile communication terminal 100 includes a button signal recognizer 162, an additional function performer 164, and a memory 166.

The button signal recognizer 162 generates an additional function event signal according to a previously set form of a button signal generated from a button formed on a side of the mobile communication terminal 100. For example, the button signal recognizer 162 may recognize whether or not button signals are input from at least two of buttons formed on a side of the mobile communication terminal 100 at the same time, and generate the additional function event signal. As an example, referring to FIG. 9, when a user simultaneously presses the home button 102-1 formed on the right side of the mobile communication terminal 100 and the option button 102-3 formed on the left side of the mobile communication terminal 100, button signals are input from the home button 102-1 and the option button 102-3 to the button signal recognizer 162 at the same time. In this case, the button signal recognizer 162 generates and transfers the additional function even signal to the additional function performer 164.

Although a case in which a user simultaneously presses buttons respectively formed on different sides of the mobile communication terminal 100 has been mentioned above, the additional function event signal is generated in not only this case but also a case in which the user simultaneously presses two buttons formed on the same side of the mobile communication terminal 100. Also, it has been described above that the button signal recognizer 162 generates the additional function event signal when button signals are input from at least two of buttons formed on a side of the mobile communication terminal 100 at the same time, but generation of the additional function event signal is not limited to this case. For example, when a button signal is generated for a predetermined period of time from any one button formed on a side of the mobile communication terminal 100, the button signal recognizer 162 may generate the additional function event signal. Also, when the user causes a button signal to be generated twice in succession from any one button formed on a side of the mobile communication terminal 100, the button signal recognizer 162 may generate the additional function event signal.

When the additional function event signal is generated, the additional function performer 164 performs an additional function previously set in an application currently executed in the mobile communication terminal 100 or a current screen state. Specifically, when the additional function event signal is generated, the additional function performer 164 checks the application currently executed in the mobile communication terminal 100 or the current screen state, and then checks the additional function set in the application or the current screen state in the memory 166 to perform the additional function. At this time, the additional function performer 164 may display the performed additional function on the display 150.

Here, an additional function previously set in an application or a current screen state may be as follows. For example, in a memo application, an additional function of displaying an editing window as a toolbar may be previously set. Here, the editing window may include menus that are frequently used in the memo application, for example, menus for selecting kinds of pencils and an eraser menu. In an Internet application, an additional function of displaying a list of Internet windows that have been generated up to the current point in time may be previously set. In a keyboard application, an additional function of converting the Korean keyboard and the English keyboard into each other and displaying the converted keyboard may be previously set. In this case, using the additional function, it is possible to immediately convert the Korean keyboard into the English keyboard or vice versa. In a music application, an additional function of displaying a music play list may be previously set. Also, an additional function of displaying a list of recently executed applications when a current screen state of the mobile communication terminal 100 is a home screen may be previously set.

In this way, by performing an additional function previously set in a currently executed application or a current screen state when the additional function event signal is generated, an additional function of each application can be easily performed with only one hand, and convenience for one-hand manipulation of the mobile communication terminal 100 can be improved.

In exemplary embodiment of the present invention, some or all buttons of a basic button unit are formed on a side of a mobile communication terminal, and thus it is possible to accurately manipulate the mobile communication terminal by pressing the basic button unit with a finger of one hand (left or right hand) while holding the mobile communication terminal in the hand. In this case, even a person with only one hand, a person with two hands one of which is disabled, a person holding an object in one hand, etc. can easily manipulate the mobile communication terminal with only one hand, and convenience of the users can be improved. In this way, users in various physical conditions or situations are taken into consideration, and thus it is possible to ensure a user-friendly and emotional marketing point. Also, by providing a mobile communication terminal of a new structure differentiated from a mobile communication terminal of a conventional structure, it is possible to achieve a creative and innovative company image that leads the corresponding field.

Since the whole basic button unit is formed on a side of the mobile communication terminal, no additional touch module such as a conventional basic button unit is necessary at the lower end of the front of the mobile communication terminal. In this case, a design and structure of the mobile communication terminal can be simplified compared to a conventional mobile communication terminal. Also, the size and weight of the mobile communication terminal can be reduced by the size and weight of a touch module compared to a conventional mobile communication terminal.

In addition, when the mobile communication terminal is formed in the same size as a conventional mobile communication terminal, a portion in which a conventional basic button unit has been present (i.e., a portion in which a touch module has been present) can be included in a display screen, and it is possible to provide a bigger screen. Also, since a battery size can be expanded to the portion in which a conventional basic button unit has been present, it is possible to increase a battery capacity. Moreover, simplification of a button structure improves the convenience and efficiency of post-sales customer service, and so on.

Furthermore, by forming the basic button unit on the side of the mobile communication terminal, it is possible to extend the width of the mobile communication terminal as well as the length as long as a user can hold the mobile communication terminal with one hand. Thus, it is possible to satisfy the user's demand for a large screen and also to provide convenience for one-hand manipulation. In other words, by forming the basic button unit on the side of the mobile communication terminal, the user can easily manipulate the mobile communication terminal with one hand even when the size of the mobile communication terminal increases. Accordingly, it is possible to keep up with a trend in the increasing size of a mobile communication terminal and also to improve convenience of the user.

It will be apparent to those skilled in the art that various modifications can be made to the above-described exemplary embodiments of the present invention without departing from the spirit or scope of the invention. Thus, it is intended that the present invention covers all such modifications provided that they come within the scope of the appended claims and their equivalents.

What is claimed is:

1. A mobile communication terminal having a basic button unit comprising a home button, a back button, an option button, a search button, or a combination thereof, wherein at least one button of the basic button unit is formed on a side of the mobile communication terminal.

2. The mobile communication terminal of claim 1, wherein the button of the basic button unit formed on the side of the mobile communication terminal is a press-type button.

3. The mobile communication terminal of claim 1, wherein all the buttons of the basic button unit are on the side of the mobile communication terminal, and
a display screen of the mobile communication terminal is extended to a lower end of a front of the mobile communication terminal.

4. The mobile communication terminal of claim 1, further comprising:
a button signal recognizer configured to generate an additional function event signal according to a previously set form of a button signal generated from the button formed on the side of the mobile communication terminal; and
an additional function performer configured to perform an additional function previously set in an application currently executed in the mobile communication terminal or a current screen state when the additional function event signal is generated.

5. The mobile communication terminal of claim 1, wherein the basic button unit comprises plural buttons;
some buttons of the basic button unit are formed at an upper end of a left side of the mobile communication terminal, and
the other buttons are formed at an upper end of a right side of the mobile communication terminal.

6. The mobile communication terminal of claim 5, wherein button functions of the respective buttons of the basic button unit are exchanged according to a setting of a user.

7. A mobile communication terminal having a basic button unit comprising at least one button formed on a side of the mobile communication terminal, said at least one button performing a function of at least one of a home button, a back button, an option button, a search button, or a combination thereof.

8. The mobile communication terminal of claim 7, wherein said at least one button is a press-type button.

9. The mobile communication terminal of claim 7, wherein the basic button unit comprises a single button.

10. The mobile communication terminal of claim 7, wherein the basic button unit comprises a plurality of buttons.

11. The mobile communication terminal of claim 10, wherein all the buttons of the basic button unit are on the side of the mobile communication terminal, and
a display screen of the mobile communication terminal is extended to a lower end of a front of the mobile communication terminal.

12. The mobile communication terminal of claim 10, further comprising:
a button signal recognizer configured to generate an additional function event signal according to a previously set form of a button signal generated from the button formed on the side of the mobile communication terminal; and
an additional function performer configured to perform an additional function previously set in an application currently executed in the mobile communication terminal or a current screen state when the additional function event signal is generated.

13. The mobile communication terminal of claim 12, wherein a first button of the plurality of buttons is positioned on a right side of the mobile communication terminal, and a second button of the plurality of buttons is positioned on a left side of the mobile communication terminal; and
the previously set form the button signal is generated when said first and second buttons are pressed at the same time.
